(19) United States
(12) Patent Application Publication
(10) Pub. No.: US 2004/0088541 A1
(43) Pub. Date: May 6, 2004

(54) Digital-rights management system

(76) Inventors: Thomas Messerges, Schaumburg, IL (US); Ezzat A. Dabbish, Cary, IL (US); Larry Puhl, Dundee, IL (US); Dean Vogler, Algonquin, IL (US)

Correspondence Address: MOTOROLA, INC., 1303 EAST ALGONQUIN ROAD, IL01/3RD, SCHAUMBURG, IL, 60196

(21) Appl. No.: 10/286,675

(22) Filed: Nov. 1, 2002

(51) Int. Cl. H04L 9/00

(52) U.S. Cl. 713/156

(57) ABSTRACT

Devices (101) are assigned a unique, unalterable, identification or serial number (313) that acts as the devices “electronic” biometric. Any certificate (302) created by a key issuer will contain the device's assigned DRM public key and the device's electronic biometric data. When a consumer wishes to purchase new content (304) from a content provider (103), the consumer will send the DRM certificate containing its DRM public key and the biometric. The rights issuer will then create a license (306) that assigns the content in such a way that only a device with the particular biometric and DRM private key is allowed to render the content.

### FIELD OF THE INVENTION

The present invention relates generally to digital-rights management and in particular, to a method, apparatus, and system for performing digital-rights management.

### BACKGROUND OF THE INVENTION

The ease at which valuable digital content (e.g., music, games, video, pictures, and books) can be copied and shared is worrisome to content owners. It is critical that content owners are fairly reimbursed. Because of this, it is a requirement that content distributors implement secure measures that help prevent piracy. Digital-Rights Management (DRM) is a popular phrase used to describe such protection of rights and the management of rules related to accessing and processing digital items. Content owners hope to protect their valuable digital content using DRM that is implemented by secure, tamper-resistant electronic devices.

Prior-art DRM protection schemes utilize a password or voucher to lock content to a single device or user, however unscrupulous consumers tend to share passwords/vouchers among users so that all may partake in the use of the content. In order to address this issue prior-art approaches have allowed individuals to share content among a domain of devices only if such devices share a common trait. This trait (e.g., a group ID, password, or a cryptographic key) is a piece of data that must be securely stored in each device of the domain so that it cannot be shared with devices outside the domain. Typically, the piece of data that identifies a domain is a DRM private/public key pair. The DRM private key is kept secret and stored securely in each device of the domain, and the DRM public key is used to cryptographically bind content to devices in the domain. A server, referred to as a Key Issuer (KI), manages enrollment and removal of devices from a domain by securely managing the distribution of DRM keys. Software inside a device and protocols between devices and the KI will use the DRM key(s) to enforce DRM rules.

Even utilizing the above DRM scheme, a DRM system is always a potential target of attack. Whether for fun or profit, attackers may look to the DRM servers (e.g., the KI) or the electronic devices themselves to try and find weaknesses. Assigned traits, such as the domain keys, are a potential area of weakness and therefore a potential avenue for attack. For example, a KI can monitor for fraud by tracking a device's public key. However, since keys are assigned and are not necessarily permanent, this approach is potentially flawed. Thus, domain management and DRM enforcement is potentially made weaker when based on an assigned trait (e.g., a key). Therefore, a need exists for a digital-rights management scheme that reduces the chances of unscrupulous users gaining access to content that a rights issuer wishes to keep secure.

### BRIEF DESCRIPTION OF THE DRAWINGS

FIG. 1 is a block diagram of a digital-rights management system in accordance with the preferred embodiment of the present invention.

FIG. 2 is a flow chart showing operation of the digital-rights management system of FIG. 1 in accordance with the preferred embodiment of the present invention.

FIG. 3 is a block diagram of the user equipment of FIG. 1 in accordance with the preferred embodiment of the present invention.

FIG. 4 is a flow chart showing operation of the user equipment of FIG. 3 in accordance with the preferred embodiment of the present invention.

FIG. 5 is a flow chart showing operation of the key issuer of FIG. 1 in accordance with the preferred embodiment of the present invention.

FIG. 6 is a flow chart showing operation of the content provider, or rights issuer, of FIG. 1 in accordance with the preferred embodiment of the present invention.

FIG. 7 is a block diagram showing the interaction between multiple user equipments of FIG. 1 and the key issuer of FIG. 1 in accordance with an alternate embodiment of the present invention.

FIG. 8 is a block diagram, showing the interaction between multiple user equipments of FIG. 1 and the rights issuer of FIG. 1 in accordance with an alternate embodiment of the present invention.

### DETAILED DESCRIPTION OF THE DRAWINGS

To address the need for a tamper-resistant, digital-rights management scheme, a method, apparatus, and system for performing DRM is provided herein. In accordance with the preferred embodiment of the present invention, devices are assigned a unique, unalterable, identification or serial number (SN) (identification attribute) that acts as the devices “electronic” biometric. Any certificate created by a key issuer will contain the device's assigned DRM public key and the device's electronic biometric data. When a consumer wishes to purchase new content from a content provider (rights issuer), the consumer will send the certificate containing its DRM public key and the biometric. The rights issuer will then create a license that assigns the content in such a way that only a device with the particular biometric and DRM public key is allowed to render the content.

Because each device contains its own unique electronic biometric and DRM keys, and because the license that assigns the content allows for only devices with the particular biometric and DRM keys to execute the content, the chances of an unscrupulous user gaining access to secure content is greatly reduced.

The present invention encompasses a method for equipment to execute digital content. The method comprises the steps of determining if an identification attribute existing within the equipment matches an identification attribute existing within a Digital Rights Management (DRM) certificate, decrypting an encrypted encryption key to obtain a decrypted encryption key, and decrypting the digital content with the encryption key. The digital content is then executed

The present invention additionally encompasses a method for issuing digital content. The method comprises the steps of receiving a request to provide digital content to user equipment, and receiving a DRM certificate along with the request. In the preferred embodiment of the present invention the DRM certificate comprises an identification attribute that identifies equipment that is to receive the digital content. The present invention additionally encompasses the steps of determining capabilities of the equipment based on the identification attribute, encrypting the digital content with a content encryption key, encrypting the content encryption key, and transferring the encrypted digital content and the encrypted content encryption key to the user equipment.

The present invention additionally encompasses a method for provisioning a DRM and DRM private key to user equipment. The method comprising the steps of receiving a unit certificate from the user equipment, the unit certificate comprising an identification attribute existing within the user equipment and a unit public key, creating the DRM certificate, the DRM certificate comprising the identification attribute and a DRM public key, creating a DRM private key, and transmitting the DRM certificate and the DRM private key to the user equipment.

The present invention additionally encompasses an apparatus comprising a unique, unalterable identification attribute, encrypted digital content an encrypted content encryption key, a DRM private key, a DRM certificate, and logic circuitry. In the preferred embodiment of the present invention the logic circuitry analyzes the identification attribute to determine if the identification attribute matches the identification attribute contained within the DRM certificate and if so, utilizes the DRM private key to decrypt the encrypted content encryption key, and utilizing the content encryption key to decrypt the digital content.

Finally, the present invention encompasses DRM system. The DRM system comprises first user equipment belonging to a group of users, the first user equipment comprising a unique, unalterable identification attribute, encrypted digital content that is shared among the group of users, an encrypted content encryption key that is shared among the group of users, a DRM private key that is shared among the group of users, a DRM certificate, and logic circuitry. As discussed the logic circuitry analyzes the identification attribute to determine if the identification attribute matches the identification attribute contained within the DRM certificate and if so, utilizes the DRM private key to decrypt the encrypted content encryption key, and utilizing the content encryption key to decrypt the digital content.

Prior to describing the DRM system in accordance with the preferred embodiment of the present invention the following definitions are provided to set the necessary background for utilization of the preferred embodiment of the present invention.

Public-Key Cryptography—Cryptographic technique that uses a pair of keys, a public and a private key. The private key is used for either decrypting data or generating digital signatures and the public key is used for either encrypting data or verifying digital signatures.

Certificate—A digital certificate is block of data issued by a trusted certification authority. It contains expiration dates and a copy of the certificate holder's public key and identification data (e.g., address or serial number). The certificate-issuing authority signs the digital certificate so that a recipient can verify that the certificate is valid and thereby authenticate the certificate holder. Some digital certificates conform to a standard, X.509.

Digital signature—A digital signature (not to be confused with a digital certificate) is an electronic signature that can be used to authenticate the identity of the sender of a message or the signer of a document, and possibly to ensure that the original content of the message or document that has been sent is unchanged.

Digitally-signed object—a digital object comprised of data that is digitally signed. The digital signature is attached to the object.

Authentication—The process of determining whether someone or something is, in fact, who or what it is declared to be. Authentication of a device or user can entail the use of a digital certificate and a challenge response protocol that involves the use of public-key cryptography. Authentication of a certificate entails verification of the digital signature of the certificate.

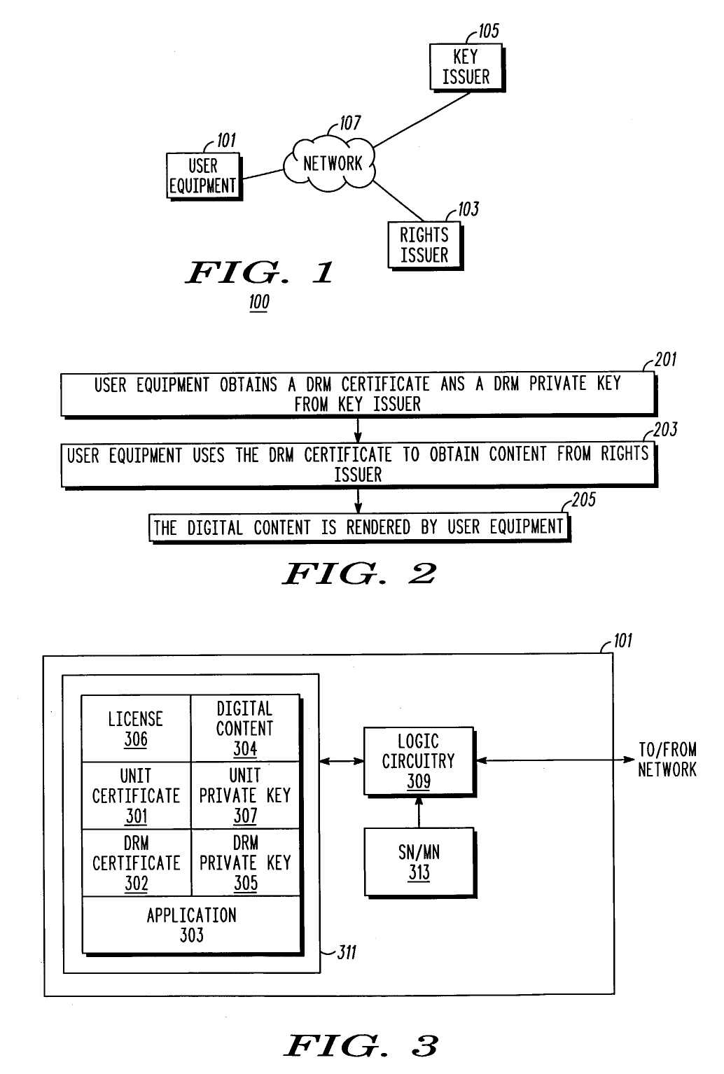

Turning now to the drawings, wherein like numerals designate like components, FIG. 1 is a block diagram of a DRM system in accordance with the preferred embodiment of the present invention. As shown, DRM system 100 comprises user equipment 101, key issuer 103, rights issuer 105, and network 107.

User equipment 101 comprises those devices such as computers, cellular telephones, personal digital assistants, . . . , etc. that are capable of running an application that renders digital content. For example, user equipment 101 may be a personal computer equipped with an application to “play” an MPEG Audio Layer 3 (MP3) file, with an application such as a standard MP3 player. Similarly, user equipment 101 may comprise a cellular telephone equipped to play an MPEG Video Layer 4 file with a standard MPEG video codec. Other possible embodiments for user equipment 101 include, but are not limited to, set-top boxes, car radios, networked MP3 players, wireless PDA, . . . , etc. Other possible embodiments for digital content include, but are not limited to music, games, video, pictures, books, maps, software, etc.

Key issuer 105 comprises an application that establishes authenticated communications with user equipment 101 and then provides user equipment 101 with a DRM certificate. The DRM certificate is utilized by user equipment 101 to obtain rights objects from rights issuer 103. Rights issuer 103 utilizes the DRM certificate to authenticate equipment 101 and pass digital content, along with the rights associated with that content (license) to user equipment 101.

In accordance with the preferred embodiment of the present invention all communication between devices takes place over network 107. Network 107 may take various forms such as but not limited to a cellular network, a local-area network, a wide-area network, . . . , etc. For example, user equipment 101 may comprise a standard cellular telephone, with network 107 comprising a cellular network such as a Code-Division, Multiple-Access communication system.

Regardless of the form that user equipment 101, network 107, and rights issuer 103 take, it is contemplated that these elements within DRM system 100 are configured in well known manners with processors, memories, instruction sets, and the like, which function in any suitable manner to perform the function set forth herein.

As discussed above equipment 101 comprises unique, unalterable, identification attributes (such as a unique serial number (SN) and a model number (MN)) identifying the particular piece of equipment 101. For example, the SN might uniquely identify the equipment 101 and the MN might indicate the capabilities associated with that equipment 101 (e.g., the version of DRM software it supports) Preferably, this serial number is provided to equipment 101 during manufacture and is not alterable in any way by the user of equipment 101. User equipment 101 also comprises a unit private key/public key pair that is utilized to establish authenticated communications with key issuer 105. More particularly, user equipment 101 contains a first unit certificate that contains the equipment's model and serial numbers along with the unit public key. It is contemplated that prior to any authentication using this unit certificate, the authentication process will have user equipment 101 authenticate this unit certificate and check its own serial number to verify that the unit certificate utilized for authenticating also contains the serial number for user equipment 101. Thus operation of DRM system 100 occurs as follows:

User equipment 101 is manufactured with a unique unalterable serial number, model number, unit certificate, and unit private key. When a user purchases equipment 101, the user must obtain rights to download/access digital content. In order to obtain these rights, key issuer 105 will grant equipment 101 with a DRM certificate and DRM private key, allowing equipment 101 to obtain and access digital content. In order to obtain the DRM certificate and private key, user equipment 101 must first authenticate with key issuer 105 utilizing the unit certificate and unit private key.

When authenticating with key issuer 105, user equipment 101 will first authenticate its own unit certificate using a verification process. This process should ensure that the unit certificate signature is verified, the SN and MN are checked against the SN and MN installed in the equipment 101, and the unit private key is tested to see if it and the unit public key in the unit certificate form a valid public key pair. If so, the validation process succeeds, and the unit certificate is provided to key issuer 105 and the unit private key is used in an authentication protocol, for example, the Wireless Transport Layer Security (WTLS) protocol. Key issuer 105 authenticates the unit certificate, determines the model number and serial number from the unit certificate and creates a DRM certificate that contains the serial number, model number, and a public key. Key issuer 105 then sends equipment 101 the DRM certificate and a private key (DRM private key).

When a user wishes to purchase digital content from rights issuer 103, it provides rights issuer 103 with a DRM certificate. Thus in accordance with the preferred embodiment of the present invention, the DRM certificate, which contains the serial number, DRM public key, and possibly the model number for equipment 101, is provided to rights issuer 103. The rights issuer will verify the authenticity of the DRM certificate and possibly process the serial and model numbers. For example, the rights issuer 103 may check fraud lists to make sure the equipment 101 with the given serial number is not listed, or the rights issuer 103 may use the model number to determine the capabilities of equipment 101 so that it knows what type of DRM protection the equipment 101 can provide.

Rights issuer 103 then provides the encrypted digital content along with a digitally signed license (rights object). In accordance with the preferred embodiment of the present invention the license contains an encrypted encryption key (content encryption key) needed to render (execute) the digital content. The content encryption key can only be obtained by applying the DRM private key to decrypt the content encryption key. Again, prior to using the DRM private key to decrypt the content encryption key, user equipment 101 will first authenticate its own DRM certificate using a verification process. For example, the verification process should ensure that the DRM certificate signature is verified, the SN and MN are checked against the SN and MN installed in the equipment 101, and the DRM private key is tested to see if it and the DRM public key in the DRM certificate form a valid public-key pair. Only if this verification process succeeds can the UE be allowed to use its DRM private key to access the content.

It is important to note that to purchase content, the DRM certificate provided may not necessarily be the DRM certificate for equipment 101. This is important because, in some cases, the user might purchase content as a gift for someone else. In this case, the user provides the DRM certificate for the other device, or a link to it. Because the buyer of the content will not have the DRM private key for content, the buyer will not be able to render the content. Only the recipient of the gift (i.e., the owner of the device whose DRM certificate was used to purchase the content) will be able to access the content. When the recipient of the gift wants to execute the digital content (e.g., play an MP3 file) that recipient's equipment 101 authenticates its DRM certificate (using the process described above) to make sure its serial and model numbers agree with the serial and model numbers in the DRM certificate. If the verification process succeeds, the equipment accesses the DRM private key to decrypt the encrypted content encryption key in the rights object (license) and obtains the content encryption key needed to decrypt the digital content. Once decrypted, the content is executed.

FIG. 2 is a flow chart showing operation of the digital-rights management system of FIG. 1 in accordance with the preferred embodiment of the present invention. The logic flow begins at step 201 where user equipment 101 obtains a DRM certificate and a DRM private key from key issuer 105. As discussed above, user equipment 101 contains a unit certificate provided to it by the manufacturer of the equipment. In order to obtain a DRM certificate, as discussed above, step 201 entails establishing authenticated communications with key issuer 105. As part of establishing authenticated communications, equipment 101 first authenticates its own unit certificate using a verification process. Once complete, authentication takes place by using a standard authentication protocol, such as Wireless Transport Layer Security (WTLS). This standard authentication protocol utilizes the unit private key/public key pair. Only after authenticated communications are established with key issuer 105 will key issuer 105 provide equipment 101 with the DRM certificate and DRM private key.

DRM certificate comprises a standard certificate as known in the art, except in accordance with the preferred embodiment of the present invention; DRM certificate contains the serial number, model number, and a public key. If the DRM certificate is issued to device that is joining a group or domain of devices, then the DRM certificate may be additionally comprised of an attribute that indicates this certificate is for a domain of devices and the maximum number of devices allowed in this domain may also be indicated in the DRM certificate. A DRM private key is also sent to user equipment 101.

At step 203, user equipment 101 uses the DRM certificate to obtain content from rights issuer 103. In particular rights issuer 103 is provided with a DRM certificate. Rights issuer 103 utilizes the DRM certificate to create encrypted digital content along with a digitally signed license (rights object). As discussed above, the license contains the encrypted content encryption key needed to render the digital content. The content encryption key is only obtainable by applying the DRM private key.

Finally, at step 205, the digital content is rendered by user equipment 101. The rendering of digital content takes place by running an application specifically designed to decrypt the content and execute the content accordingly. More particularly, the application first authenticates its DRM certificate and makes sure its serial and model numbers agree with the unalterable serial number and model number, and the DRM private key is tested to see if it and the DRM public key in the DRM certificate form a valid public key pair. If so, the equipment accesses its DRM private key to decrypt the content encryption key, contained in the rights object (license). This key is then used to decrypt and execute the digital content.

FIG. 3 is a block diagram of user equipment 101 of FIG. 1 in accordance with the preferred embodiment of the present invention. As shown, user equipment 101 comprises storage 311 for storing unit certificate 301, unit private key 307, DRM certificate 302, application 303, digital content 304, DRM private key 305, and license 306. As known in the art, storage 311 may comprise any number of storage means, including, but not limited to hard disk storage, random-access memory (RAM), smart card (e.g., Wireless Identity Module used in cellular telephones), etc. User equipment 101 additionally includes logic circuitry 309, which in the preferred embodiment of the present invention comprises a microprocessor controller such as but not limited to the Motorola MC68328: DragonBall integrated microprocessor or the TI OMAP1510 processor. Finally, user equipment 101 comprises an unalterable serial number/model number. In the preferred embodiment of the present invention the model number is preferably stored in read-only memory (ROM) and the unique serial number permanently inserted into the device using a laser-etch process, however, other methods for storing the serial/model number include, but are not limited to storing these numbers in a one-time programmable memory or flash memory.

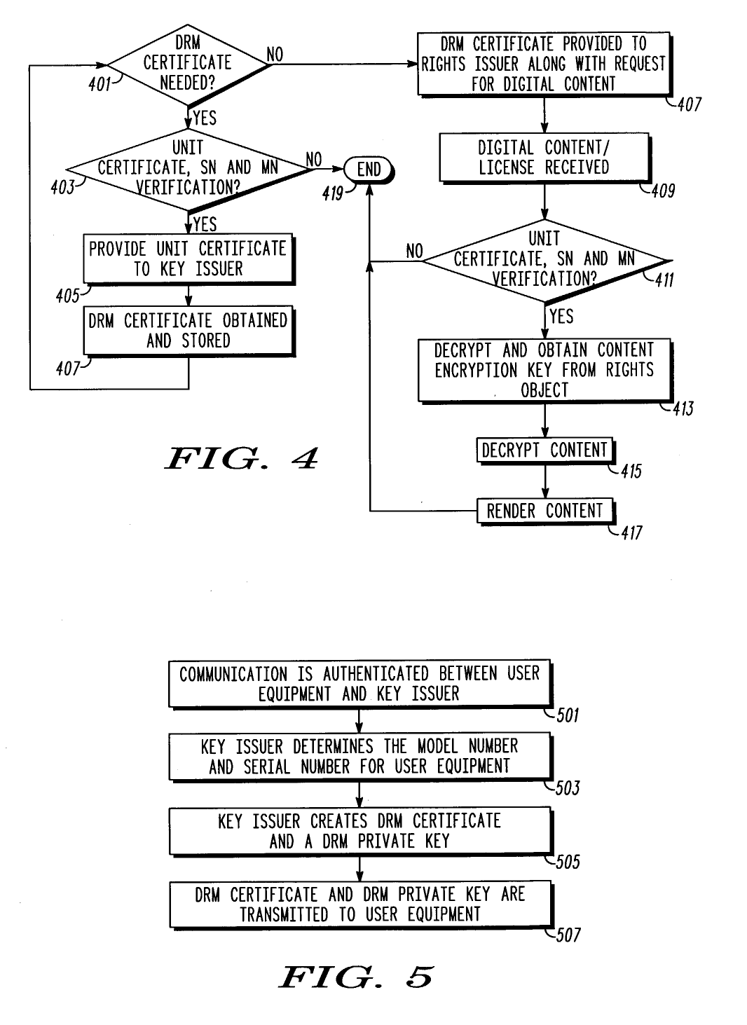

FIG. 4 is a flow chart showing operation of the user equipment of FIG. 3 in accordance with the preferred embodiment of the present invention. In particular, the following steps show those necessary to obtain digital content from a rights issuer and render the digital content. The logic flow begins at step 401 where logic circuitry 309 determines if a DRM certificate is needed. In particular, once a DRM certificate has been issued to user equipment 101, the user equipment can utilize the DRM certificate for all transactions, and does not need to obtain a new DRM certificate. Therefore, at step 401, if a DRM certificate is not needed the logic flow continues to step 407, otherwise the logic flow continues to step 403. At step 403 the unit certificate 301 and serial and model numbers undergo a verification process (as describe above the unit certificate authenticity is checked, the pairing of the unit private key and unit public key is checked and, the serial and model numbers contained in the unit certificate 301 are checked). If this verification fails, the logic flow ends at step 419. If, at step 403, the verification succeeds, the logic flow continues to step 405 where unit certificate 301 is provided to key issuer 105. At step 407, DRM certificate 302 is obtained from key issuer 105 along with DRM private key 305 and stored in memory 311. The flow can then continue back to step 401.

Once a DRM certificate 302 has been obtained, digital content can now be obtained from rights issuer 103. This process begins at step 407 where DRM certificate 302 is provided to rights issuer 103 along with a request for digital content. In response, at step 409, user equipment 101 receives digital content 304 along with license 306. These are stored in memory 311.

In order to execute the digital content, user equipment 101 must first execute the verification process on its DRM certificate 302, which involves checking that the serial number 313 matches the serial number existing within DRM certificate 302 (step 411). If this verification process succeeds, logic unit 309 accesses DRM private key 305 and uses it to decrypt the content encryption key from license 306 (step 413). At step 415 the content is decrypted, and the content is rendered by application 303 at step 417.

FIG. 5 is a flow chart showing operation of the key issuer of FIG. 5 in accordance with the preferred embodiment of the present invention. The logic flow begins at step 501 where communication is authenticated between user equipment 101 and key issuer 105. As part of this authentication, key issuer 105 is provided with unit certificate 301. From unit certificate 301, key issuer 105 determines the model number and serial (identification) number 313 for user equipment 101 (step 503). At step 505, key issuer 105 creates DRM certificate 302, and a DRM private key 305. Finally, at step 507, the DRM certificate 302 and DRM private key 305 are transmitted to user equipment 101.

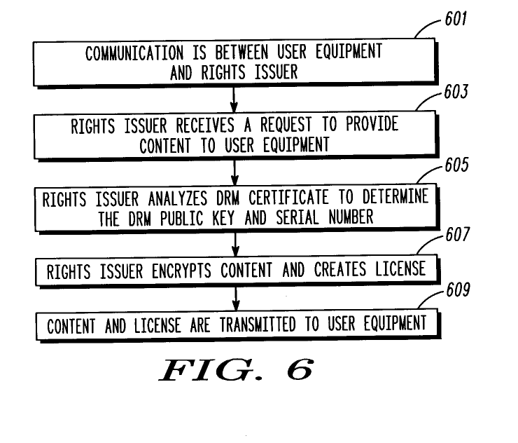

FIG. 6 is a flow chart showing operation of the content provider, or rights issuer, of FIG. 1 in accordance with the preferred embodiment of the present invention. The logic flow begins at step 601 where rights issuer 103 establishes communications with user equipment 101. At step 603 rights issuer 103 receives a request to provide content 304 to user equipment 101. Along with the request, rights issuer 103 receives DRM certificate 302. At step 605 rights issuer 103 analyzes DRM certificate to determine the DRM public key, serial and model number 313. Rights issuer 103 then encrypts content 304 and creates license 306 (step 607) that assigns content 304 in such a way that only a device with access to DRM private key 305 will be able to render content 304. In particular, license 306 comprises an encrypted encryption key needed to decrypt content 304. The key used to encrypt the content can be decrypted by applying DRM private key 305. Finally, at step 609, content 304 and license 306 are transmitted to user equipment 101.

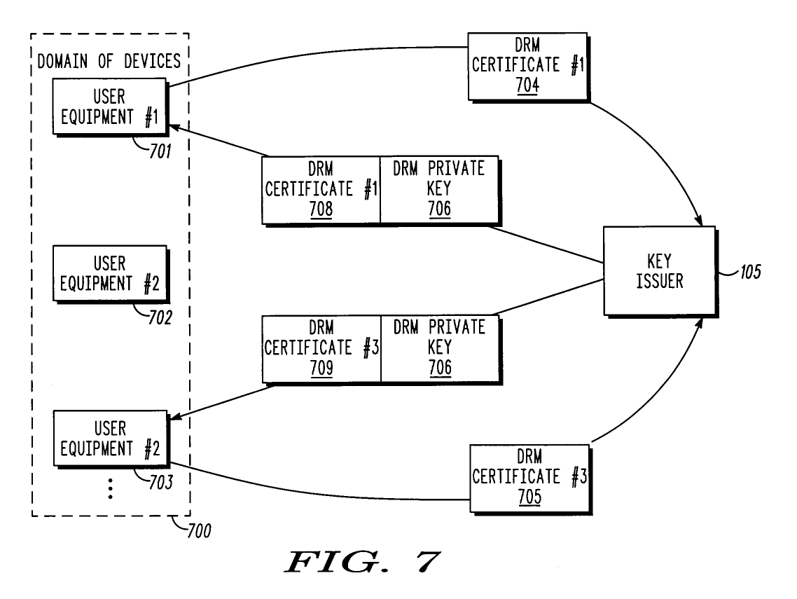

The present invention can also be used to implement a domain-based DRM system, where multiple users can form a group to share access to the same digital content. FIG. 7 is a block diagram of the interaction between multiple user equipment 101 of FIG. 1 and the key issuer 105 of FIG. 1 in accordance with the preferred embodiment of the present invention. In FIG. 7, equipment 701, 702, and 703 are individual and distinct embodiments of the user equipment 101 from FIG. 1. User equipment 701, 702, 703 are also part of a domain of devices 700, which may contain a limited number of devices. The domain of devices can be established as discussed above with reference to FIG. 5. These steps require the transfer of certificates and keys as shown in FIG. 7. That is, user equipment 701 securely sends its unit certificate 704 to the key issuer 105. Then, key issuer 105 securely sends DRM certificate 708 and DRM private key 706 back to user equipment 701. Likewise, user equipment 703 securely sends its unit certificate 705 to the key issuer 105. Then, key issuer 105 securely sends DRM certificate 709 and DRM private key 706 back to user equipment 703. Since user equipment 701 and 703 now share the same DRM private key 706, they are now in the same domain of devices 700 and they can share content assigned to this domain (e.g., they can decrypt content encryption keys with their common DRM private key 706). In effect, FIG. 7 shows that the key issuer 105 can act as the domain manager and allow a multiple, but limited, number of devices to be provisioned with the same DRM private key 706.

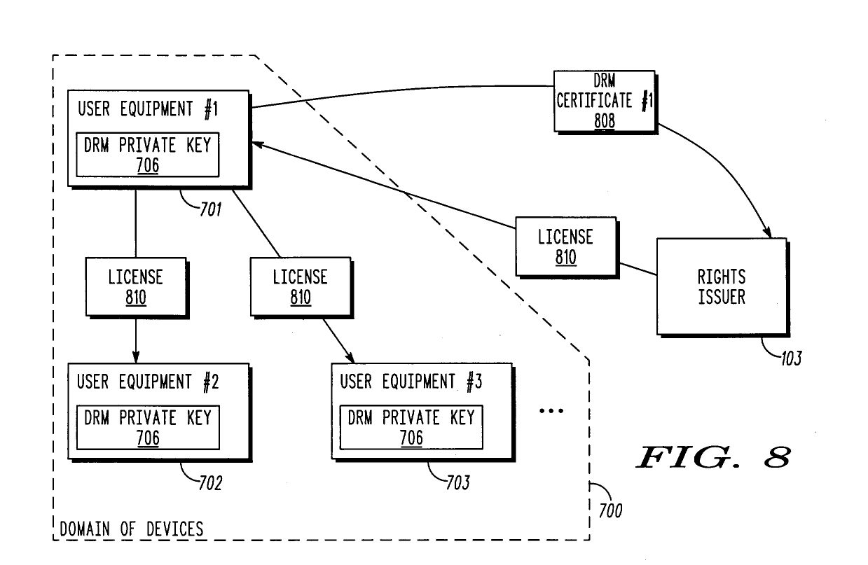

FIG. 8 is a block diagram of the interaction between multiple user equipment 101 of FIG. 1 and the rights issuer 103 of FIG. 1 in accordance with the preferred embodiment of the present invention. In FIG. 8, user equipment 701, 702, and 703 are all part of a domain of devices 700 and share a common DRM private key 706 (from FIG. 7). A rights object, or license, for a digital item can be obtained as described in FIG. 6. These steps require the transfer of objects shown in FIG. 8. That is, user equipment 701 sends its DRM certificate 808 to rights issuer 103. Rights issuer 103 then sends license 810 to user equipment 701. As shown in FIG. 8, license 810 can be shared with user equipment 702 and 703. Since user equipment 701, 702, and 703 share the same DRM private key 706 (i.e., they are in the same domain of devices), each device can decrypt the encrypted content encryption key contained in license 810. Therefore, the keys, certificates, and license described in the preferred embodiment of this invention enable a DRM system that allows for domain of devices 700.

While the invention has been particularly shown and described with reference to a particular embodiment, it will be understood by those skilled in the art that various changes in form and details may be made therein without departing from the spirit and scope of the invention. For example, although the above description was given with respect to utilizing a unique, unalterable serial number/model number, one of ordinary skill in the art will recognize that any embedded number may be utilized to perform the above DRM scheme. It is intended that such changes come within the scope of the following claims.

1. A method for equipment to execute digital content, the method comprising the steps of:
determining if an identification attribute existing within the equipment matches an identification attribute existing within a Digital Rights Management (DRM) certificate;
decrypting an encrypted encryption key to obtain a decrypted encryption key;
decrypting the digital content with the encryption key; and
executing the digital content.

2. The method of claim 1 wherein the step of determining if an identification attribute matches an identification attribute existing within the DRM certificate comprises the step of determining if a unique, unalterable serial number existing within the equipment matches a serial number existing within the DRM certificate.

3. The method of claim 1 wherein the step of decrypting the encrypted encryption key comprises the step of decrypting the encrypted encryption key only if the identification attribute existing within the equipment matches the identification attribute existing within the Digital Rights Management (DRM) certificate.

4. A method for issuing digital content, the method comprising the steps of:
receiving a request to provide digital content to user equipment;
receiving a DRM certificate along with the request, the DRM certificate comprising an identification attribute that identifies equipment that is to receive the digital content;
determining capabilities of the equipment based on the identification attribute;
encrypting the digital content with a content encryption key;
encrypting the content encryption key;
transferring the encrypted digital content and the encrypted content encryption key to the user equipment.

5. The method of claim 4 wherein the step of receiving the DRM certificate comprises the step of receiving a DRM certificate comprising a DRM public key, and the step of encrypting the content encryption key comprises the step of utilizing the DRM public key to encrypt the content encryption key.

6. A method for provisioning a digital-rights management (DRM) certificate and DRM private key to user equipment, the method comprising the steps of:
receiving a unit certificate from the user equipment, the unit certificate comprising an identification attribute existing within the user equipment and a unit public key;
creating the DRM certificate, the DRM certificate comprising the identification attribute and a DRM public key;
creating a DRM private key; and
transmitting the DRM certificate and the DRM private key to the user equipment.

7. The method of claim 6 wherein the step of receiving the unit certificate comprises the step of receiving the unit certificate comprising a unique, unalterable serial number that exists within the user equipment.

8. An apparatus comprising:
a unique, unalterable identification attribute (313);
encrypted digital content (304);
an encrypted content encryption key (306);
a DRM private key (306);
a DRM certificate (302); and
logic circuitry (309), wherein the logic circuitry analyzes the identification attribute to determine if the identification attribute matches the identification attribute contained within the DRM certificate (302) and if so, utilizes the DRM private key (306) to decrypt the encrypted content encryption key, and utilizing the content encryption key to decrypt the digital content.

9. The apparatus of claim 8 further comprising:
an application (303) to execute the decrypted digital content.

10. The apparatus of claim 9 wherein the unique, unalterable identification attributes comprises a unique, unalterable serial number.

11. The apparatus of claim 9 wherein the unique, unalterable identification attribute comprises a unique, unalterable serial number and model number.

12. A digital-rights management (DRM) system, the DRM system comprising:
first user equipment belonging to a group of users, the first user equipment comprising:
a unique, unalterable identification attribute (313);
encrypted digital content (304) that is shared among the group of users;
an encrypted content encryption key (306) that is shared among the group of users;
a DRM private key (306) that is shared among the group of users;
a DRM certificate (302); and
logic circuitry (309), wherein the logic circuitry analyzes the identification attribute to determine if the identification attribute matches the identification attribute contained within the DRM certificate (302) and if so, utilizes the DRM private key (306) to decrypt the encrypted content encryption key, and utilizing the content encryption key to decrypt the digital content.

13. The DRM system of claim 12 further comprising:
second user equipment belonging to the group of users, the second user equipment comprising:
a unique, unalterable identification attribute (313);
the encrypted digital content (304) that is shared among the group of users;
the encrypted content encryption key (306) that is shared among the group of users;
the DRM private key (306) that is shared among the group of users;
a second DRM certificate (302); and
logic circuitry (309), wherein the logic circuitry analyzes the identification attribute to determine if the identification attribute matches the identification attribute contained within the DRM certificate (302) and if so, utilizes the DRM private key (306) to decrypt the encrypted content encryption key, and utilizing the content encryption key to decrypt the digital content.
